(19) United States
(12) Patent Application Publication
(10) Pub. No.: US 2025/0298995 A1
(43) Pub. Date: Sep. 25, 2025

(54) LANGUAGE CAPABILITY EVALUATION OF LARGE LANGUAGE MODELS

(71) Applicant: Zoom Video Communications, Inc., San Jose, CA (US)

(72) Inventors: Shamil Chollampatt Muhammed Ashraf, Singapore (SG); Sathish Reddy Indurthi, Cupertino, CA (US); Minh-Quang Pham, Karlsruhe (DE); Marco Turchi, Pergine Valsugana (IT)

(73) Assignee: Zoom Video Communications, Inc., San Jose, CA (US)

(21) Appl. No.: 18/610,552

(22) Filed: Mar. 20, 2024

(51) Int. Cl. G06F 40/51; G06N 3/0475

(52) U.S. Cl. CPC G06F 40/51; G06N 3/0475

(57) ABSTRACT

Systems and methods for language capability evaluation of large language models are provided. A communication platform accesses a pair of parallel inputs, including a reference input in a reference language corresponding to a target input in a target language different from the reference language. The communication platform executes a reference large language model for the generative task to obtain a reference output in the reference language based on the reference input. The communication platform executes a target large language model for the generative task to obtain a target output in the target language based on the target input. The communication platform evaluates a cross-lingual similarity between the target output and the reference output to obtain an evaluation score. The communication platform fine-tunes the target large language model based on the evaluation score using a reinforcement learning algorithm.

### FIELD

The present application generally relates to large language models and more specifically relates to language capability evaluation of large language models.

### BRIEF DESCRIPTION OF THE DRAWINGS

The accompanying drawings, which are incorporated into and constitute a part of this specification, illustrate one or more certain examples and, together with the description of the example, serve to explain the principles and implementations of the certain examples.

FIG. 1 shows an example system that provides chat and videoconferencing functionalities to various client devices;

FIG. 2 shows an example system in which a chat and video conference provider provides chat and videoconferencing functionalities to various client devices;

FIG. 3 shows an example system for using LLMs to perform certain generative tasks based on communication data on a communication platform;

FIG. 4 shows an example system where a model evaluation engine on a communication platform evaluates language capabilities of large language models;

FIG. 5 shows an example method of evaluating language capabilities of large language models;

FIG. 6 shows an example computing device suitable for use with example systems and methods for evaluating language capabilities of large language models.

### DETAILED DESCRIPTION

Examples are described herein in the context of language capability evaluation of large language models. Those of ordinary skill in the art will realize that the following description is illustrative only and is not intended to be in any way limiting. Reference will now be made in detail to implementations of examples as illustrated in the accompanying drawings. The same reference indicators will be used throughout the drawings and the following description to refer to the same or like items.

In the interest of clarity, not all of the routine features of the examples described herein are shown and described. It will, of course, be appreciated that in the development of any such actual implementation, numerous implementation-specific decisions must be made in order to achieve the developer's specific goals, such as compliance with application-and business-related constraints, and that these specific goals will vary from one implementation to another and from one developer to another.

A large set of large language models (LLMs) are available in industrial and scientific fields. Each LLM has its peculiarities that can be related to its architecture, the training procedure, the training data, etc. In general, English is a high-resource language, meaning there is a vast number of datasets in English to train LLMs for various generative tasks in English. In contrast, low-resource languages are not as widely used, so there may be a lack of datasets for training LLMs to perform certain generative tasks in such languages. Even among high-resource languages, available training datasets are currently in disproportion with those in English. It is not easy to determine which LLM, among multiple LLMs, performs the best in any particular language, because each LLM is trained in different conditions, which makes it hard to make a proper horizontal comparison. In addition, it usually requires human-quality outputs to evaluate certain tasks performed by an LLM. However, generating human outputs are costly. In some situations, a user uses a specific LLM (e.g., GPT-4) as an evaluator. However, the score generated by the specific LLM may not be accurate. Plus, the specific LLM can be biased on its own ability or related models' abilities for certain tasks in certain languages. In some situations, a user just resorts to the most popular LLM, which may not be the best one for the particular language. For example, GPT-4 is a popular LLM. However, it may not generate a meeting summary in Swedish or another less-known language as well as another LLM does in Swedish or another less-known language.

To facilitate selecting an LLM for certain generative tasks in a non-English language, it is desirable to evaluate the performance of an LLM automatically and effectively, without requiring human generated output as reference. For example, a communication platform may provide a model evaluation engine for automatically evaluating an LLM's performance in a non-English language.

In an example, a user selects a target LLM model for evaluation. The user can provide a pair of parallel inputs including a reference input in English and a target input in Swedish. The reference input in English corresponds to the target input in Swedish. For example, the target input is a meeting transcript in Swedish for a meeting and the reference input is a meeting transcript in English for the same meeting (e.g., English translation of the Swedish meeting transcript, which can be generated using a strong translation model). The target LLM can be instructed to generate a summary of the meeting transcript. The communication platform can deploy a reference LLM (e.g., GPT-4) to obtain a reference summary in English based on the meeting transcript in English. The communication platform also deploys the target LLM to obtain a target summary in Swedish for the meeting transcript in Swedish.

A model evaluation engine on the communication platform can implement a cross-lingual evaluation metric, for example a cross-lingual embedding similarity, to evaluate a similarity between the target summary in Swedish and the reference summary in English. In some examples, the model evaluation engine generates an evaluation score representing the similarity between the target output and the reference output. The evaluation score can indicate how similar the meaning of the target output is to the meaning of the reference output. The evaluation score can be provided to the target LLM as feedback. The communication platform can implement a suitable learning algorithm, for example a reinforcement learning algorithm, to then fine-tune the target LLM.

In some examples, a user wants to have multiple LLMs evaluated for the generative task in Swedish. The communication platform then executes the multiple LLMs indicated by the user to obtain multiple outputs based on the same target input. The model evaluation engine can produce multiple evaluation scores for the multiple target outputs. The multiple evaluation scores can be ranked. The LLM corresponding to the highest evaluation score can be selected for the generative task in Swedish.

In some examples, the communication platform can detect a model change by evaluating outputs from a target LLM at different times. The target LLM is executed to generate a first output based on the target input at a first time, and a first evaluation score can be obtained by comparing the first output in Swedish with the reference output in English. In some examples, the evaluation scores are aggregated over different input instances at the first time to obtain an average evaluation score as the first evaluation score. The target LLM is executed again to generate a second output based on the same target input at a second time, and a second evaluation score can be obtained by comparing the second output in Swedish with the same reference output. In some examples, the evaluation scores are aggregated over different input instances at the second time to obtain an average evaluation score as the second evaluation score. A model change can be detected if the difference between the first evaluation score and the second evaluation score satisfies a predetermined threshold. The model change can be a positive one with performance improvement, indicated by the second evaluation score being higher than the first evaluation score. Alternatively, the model change can be a negative change, for example, a model drift or decay, indicated by the second evaluation score being lower than the first evaluation score.

Thus, with this example evaluation system and method, reference annotations (e.g., human annotations) are not needed for evaluating an LLM for a generative task. Moreover, LLMs in low-resource languages can be evaluated more accurately in a non-biased way by implementing a cross-lingual evaluation metric. A suitable LLM can be selected to perform a generative task in a non-English language more accurately and effectively among available LLMs.

This illustrative example is given to introduce the reader to the general subject matter discussed herein and the disclosure is not limited to this example. The following sections describe various additional non-limiting examples and examples of evaluating LLMs' language capabilities.

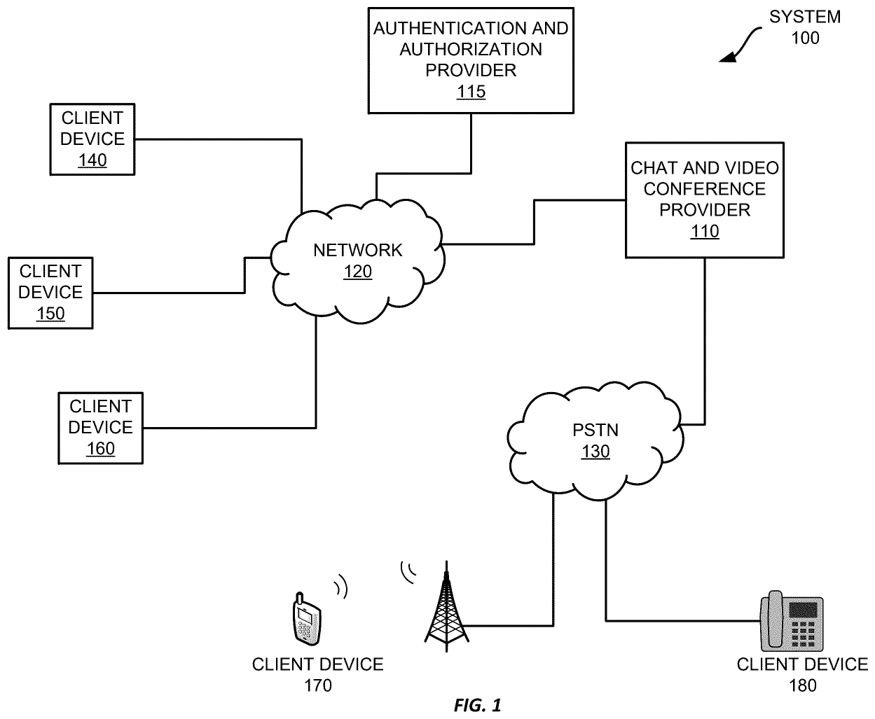

Referring now to FIG. 1, FIG. 1 shows an example system 100 that provides videoconferencing functionality to various client devices. The system 100 includes a chat and video conference provider 110 that is connected to multiple communication networks 120, 130, through which various client devices 140-180 can participate in video conferences hosted by the chat and video conference provider 110. For example, the chat and video conference provider 110 can be located within a private network to provide video conferencing services to devices within the private network, or it can be connected to a public network, e.g., the internet, so it may be accessed by anyone. Some examples may even provide a hybrid model in which a chat and video conference provider 110 may supply components to enable a private organization to host private internal video conferences or to connect its system to the chat and video conference provider 110 over a public network.

The system optionally also includes one or more authentication and authorization providers, e.g., authentication and authorization provider 115, which can provide authentication and authorization services to users of the client devices 140-160. Authentication and authorization provider 115 may authenticate users to the chat and video conference provider 110 and manage user authorization for the various services provided by chat and video conference provider 110. In this example, the authentication and authorization provider 115 is operated by a different entity than the chat and video conference provider 110, though in some examples, they may be the same entity.

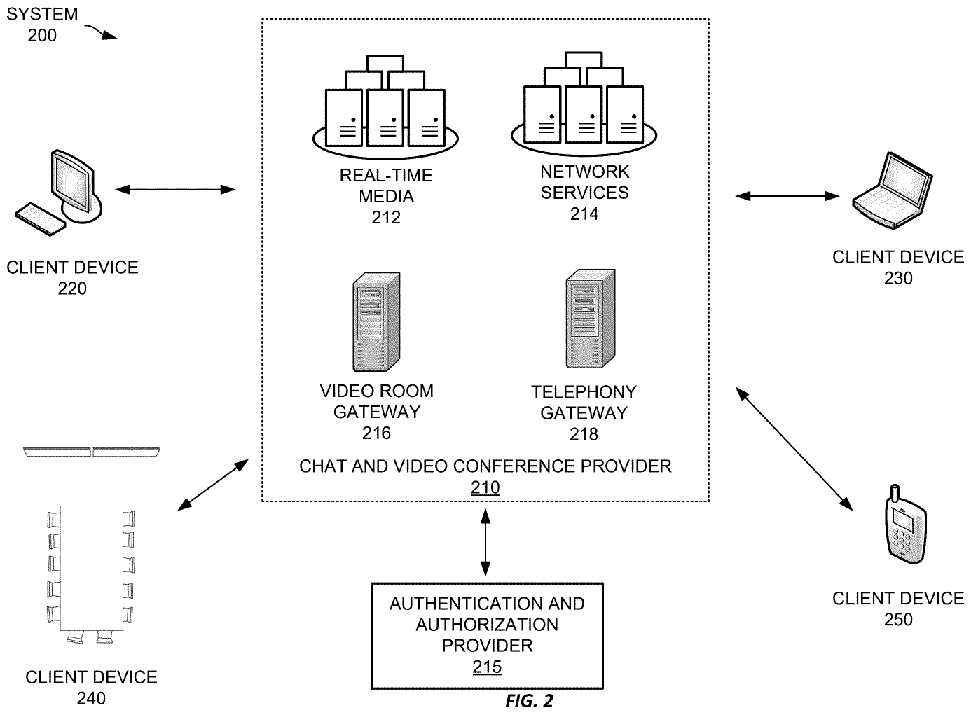

Chat and video conference provider 110 allows clients to create videoconference meetings (or “meetings”) and invite others to participate in those meetings as well as perform other related functionality, such as recording the meetings, generating transcripts from meeting audio, generating summaries and translations from meeting audio, manage user functionality in the meetings, enable text messaging during the meetings, create and manage breakout rooms from the virtual meeting, etc. FIG. 2, described below, provides a more detailed description of the architecture and functionality of the chat and video conference provider 110. It should be understood that the term “meeting” encompasses the term “webinar” used herein.

Meetings in this example chat and video conference provider 110 are provided in virtual rooms to which participants are connected. The room in this context is a construct provided by a server that provides a common point at which the various video and audio data is received before being multiplexed and provided to the various participants. While a “room” is the label for this concept in this disclosure, any suitable functionality that enables multiple participants to participate in a common videoconference may be used.

To create a meeting with the chat and video conference provider 110, a user may contact the chat and video conference provider 110 using a client device 140-180 and select an option to create a new meeting. Such an option may be provided in a webpage accessed by a client device 140-160 or a client application executed by a client device 140-160. For telephony devices, the user may be presented with an audio menu that they may navigate by pressing numeric buttons on their telephony device. To create the meeting, the chat and video conference provider 110 may prompt the user for certain information, such as a date, time, and duration for the meeting, a number of participants, a type of encryption to use, whether the meeting is confidential or open to the public, etc. After receiving the various meeting settings, the chat and video conference provider may create a record for the meeting and generate a meeting identifier and, in some examples, a corresponding meeting password or passcode (or other authentication information), all of which meeting information is provided to the meeting host.

After receiving the meeting information, the user may distribute the meeting information to one or more users to invite them to the meeting. To begin the meeting at the scheduled time (or immediately, if the meeting was set for an immediate start), the host provides the meeting identifier and, if applicable, corresponding authentication information (e.g., a password or passcode). The video conference system then initiates the meeting and may admit users to the meeting. Depending on the options set for the meeting, the users may be admitted immediately upon providing the appropriate meeting identifier (and authentication information, as appropriate), even if the host has not yet arrived, or the users may be presented with information indicating that the meeting has not yet started, or the host may be required to specifically admit one or more of the users.

During the meeting, the participants may employ their client devices 140-180 to capture audio or video information and stream that information to the chat and video conference provider 110. They also receive audio or video information from the chat and video conference provider 110, which is displayed by the respective client device 140 to enable the various users to participate in the meeting.

At the end of the meeting, the host may select an option to terminate the meeting, or it may terminate automatically at a scheduled end time or after a predetermined duration. When the meeting terminates, the various participants are disconnected from the meeting, and they will no longer receive audio or video streams for the meeting (and will stop transmitting audio or video streams). The chat and video conference provider 110 may also invalidate the meeting information, such as the meeting identifier or password/passcode.

To provide such functionality, one or more client devices 140-180 may communicate with the chat and video conference provider 110 using one or more communication networks, such as network 120 or the public switched telephone network (“PSTN”) 130. The client devices 140-180 may be any suitable computing or communication devices that have audio or video capability. For example, client devices 140-160 may be conventional computing devices, such as desktop or laptop computers having processors and computer-readable media, connected to the chat and video conference provider 110 using the internet or other suitable computer network. Suitable networks include the internet, any local area network (“LAN”), metro area network (“MAN”), wide area network (“WAN”), cellular network (e.g., 3G, 4G, 4G LTE, 5G, etc.), or any combination of these. Other types of computing devices may be used instead or as well, such as tablets, smartphones, and dedicated video conferencing equipment. Each of these devices may provide both audio and video capabilities and may enable one or more users to participate in a video conference meeting hosted by the chat and video conference provider 110.

In addition to the computing devices discussed above, client devices 140-180 may also include one or more telephony devices, such as cellular telephones (e.g., cellular telephone 170), internet protocol (“IP”) phones (e.g., telephone 180), or conventional telephones. Such telephony devices may allow a user to make conventional telephone calls to other telephony devices using the PSTN, including the chat and video conference provider 110. It should be appreciated that certain computing devices may also provide telephony functionality and may operate as telephony devices. For example, smartphones typically provide cellular telephone capabilities and thus may operate as telephony devices in the example system 100 shown in FIG. 1. In addition, conventional computing devices may execute software to enable telephony functionality, which may allow the user to make and receive phone calls, e.g., using a headset and microphone. Such software may communicate with a PSTN gateway to route the call from a computer network to the PSTN. Thus, telephony devices encompass any devices that can make conventional telephone calls and are not limited solely to dedicated telephony devices like conventional telephones.

Referring again to client devices 140-160, these devices 140-160 contact the chat and video conference provider 110 using network 120 and may provide information to the chat and video conference provider 110 to access functionality provided by the chat and video conference provider 110, such as access to create new meetings or join existing meetings. To do so, the client devices 140-160 may provide user authentication information, meeting identifiers, meeting passwords or passcodes, etc. In examples that employ an authentication and authorization provider 115, a client device, e.g., client devices 140-160, may operate in conjunction with an authentication and authorization provider 115 to provide authentication and authorization information or other user information to the chat and video conference provider 110.

An authentication and authorization provider 115 may be any entity trusted by the chat and video conference provider 110 that can help authenticate a user to the chat and video conference provider 110 and authorize the user to access the services provided by the chat and video conference provider 110. For example, a trusted entity may be a server operated by a business or other organization with whom the user has created an account, including authentication and authorization information, such as an employer or trusted third-party. The user may sign into the authentication and authorization provider 115, such as by providing a username and password, to access their account information at the authentication and authorization provider 115. The account information includes information established and maintained at the authentication and authorization provider 115 that can be used to authenticate and facilitate authorization for a particular user, irrespective of the client device they may be using. An example of account information may be an email account established at the authentication and authorization provider 115 by the user and secured by a password or additional security features, such as single sign-on, hardware tokens, two-factor authentication, etc. However, such account information may be distinct from functionality such as email. For example, a health care provider may establish accounts for its patients. And while the related account information may have associated email accounts, the account information is distinct from those email accounts.

Thus, a user's account information relates to a secure, verified set of information that can be used to authenticate and provide authorization services for a particular user and should be accessible only by that user. By properly authenticating, the associated user may then verify themselves to other computing devices or services, such as the chat and video conference provider 110. The authentication and authorization provider 115 may require the explicit consent of the user before allowing the chat and video conference provider 110 to access the user's account information for authentication and authorization purposes.

Once the user is authenticated, the authentication and authorization provider 115 may provide the chat and video conference provider 110 with information about services the user is authorized to access. For instance, the authentication and authorization provider 115 may store information about user roles associated with the user. The user roles may include collections of services provided by the chat and video conference provider 110 that users assigned to those user roles are authorized to use. Alternatively, more or less granular approaches to user authorization may be used.

When the user accesses the chat and video conference provider 110 using a client device, the chat and video conference provider 110 communicates with the authentication and authorization provider 115 using information provided by the user to verify the user's account information. For example, the user may provide a username or cryptographic signature associated with an authentication and authorization provider 115. The authentication and authorization provider 115 then either confirms the information presented by the user or denies the request. Based on this response, the chat and video conference provider 110 either provides or denies access to its services, respectively.

For telephony devices, e.g., client devices 170-180, the user may place a telephone call to the chat and video conference provider 110 to access video conference services. After the call is answered, the user may provide information regarding a video conference meeting, e.g., a meeting identifier (“ID”), a passcode or password, etc., to allow the telephony device to join the meeting and participate using audio devices of the telephony device, e.g., microphone(s) and speaker(s), even if video capabilities are not provided by the telephony device.

Because telephony devices typically have more limited functionality than conventional computing devices, they may be unable to provide certain information to the chat and video conference provider 110. For example, telephony devices may be unable to provide authentication information to authenticate the telephony device or the user to the chat and video conference provider 110. Thus, the chat and video conference provider 110 may provide more limited functionality to such telephony devices. For example, the user may be permitted to join a meeting after providing meeting information, e.g., a meeting identifier and passcode, but only as an anonymous participant in the meeting. This may restrict their ability to interact with the meetings in some examples, such as by limiting their ability to speak in the meeting, hear or view certain content shared during the meeting, or access other meeting functionality, such as joining breakout rooms or engaging in text chat with other participants in the meeting.

It should be appreciated that users may choose to participate in meetings anonymously and decline to provide account information to the chat and video conference provider 110, even in cases where the user could authenticate and employs a client device capable of authenticating the user to the chat and video conference provider 110. The chat and video conference provider 110 may determine whether to allow such anonymous users to use services provided by the chat and video conference provider 110. Anonymous users, regardless of the reason for anonymity, may be restricted as discussed above with respect to users employing telephony devices, and in some cases may be prevented from accessing certain meetings or other services, or may be entirely prevented from accessing the chat and video conference provider 110.

Referring again to chat and video conference provider 110, in some examples, it may allow client devices 140-160 to encrypt their respective video and audio streams to help improve privacy in their meetings. Encryption may be provided between the client devices 140-160 and the chat and video conference provider 110 or it may be provided in an end-to-end configuration where multimedia streams (e.g., audio or video streams) transmitted by the client devices 140-160 are not decrypted until they are received by another client device 140-160 participating in the meeting. Encryption may also be provided during only a portion of a communication, for example encryption may be used for otherwise unencrypted communications that cross international borders.

Client-to-server encryption may be used to secure the communications between the client devices 140-160 and the chat and video conference provider 110, while allowing the chat and video conference provider 110 to access the decrypted multimedia streams to perform certain processing, such as recording the meeting for the participants or generating transcripts of the meeting for the participants. End-to-end encryption may be used to keep the meeting entirely private to the participants without any worry about a chat and video conference provider 110 having access to the substance of the meeting. Any suitable encryption methodology may be employed, including key-pair encryption of the streams. For example, to provide end-to-end encryption, the meeting host's client device may obtain public keys for each of the other client devices participating in the meeting and securely exchange a set of keys to encrypt and decrypt multimedia content transmitted during the meeting. Thus, the client devices 140-160 may securely communicate with each other during the meeting. Further, in some examples, certain types of encryption may be limited by the types of devices participating in the meeting. For example, telephony devices may lack the ability to encrypt and decrypt multimedia streams. Thus, while encrypting the multimedia streams may be desirable in many instances, it is not required as it may prevent some users from participating in a meeting.

By using the example system shown in FIG. 1, users can create and participate in meetings using their respective client devices 140-180 via the chat and video conference provider 110. Further, such a system enables users to use a wide variety of different client devices 140-180 from traditional standards-based video conferencing hardware to dedicated video conferencing equipment to laptop or desktop computers to handheld devices to legacy telephony devices. etc.

Referring now to FIG. 2, FIG. 2 shows an example system 200 in which a chat and video conference provider 210 provides videoconferencing functionality to various client devices 220-250. The client devices 220-250 include two conventional computing devices 220-230, dedicated equipment for a video conference room 240, and a telephony device 250. Each client device 220-250 communicates with the chat and video conference provider 210 over a communications network, such as the internet for client devices 220-240 or the PSTN for client device 250, generally as described above with respect to FIG. 1. The chat and video conference provider 210 is also in communication with one or more authentication and authorization providers 215, which can authenticate various users to the chat and video conference provider 210 generally as described above with respect to FIG. 1.

In this example, the chat and video conference provider 210 employs multiple different servers (or groups of servers) to provide different examples of video conference functionality, thereby enabling the various client devices to create and participate in video conference meetings. The chat and video conference provider 210 uses one or more real-time media servers 212, one or more network services servers 214, one or more video room gateways 216, one or more message and presence gateways 217, and one or more telephony gateways 218. Each of these servers 212-218 is connected to one or more communications networks to enable them to collectively provide access to and participation in one or more video conference meetings to the client devices 220-250.

The real-time media servers 212 provide multiplexed multimedia streams to meeting participants, such as the client devices 220-250 shown in FIG. 2. While video and audio streams typically originate at the respective client devices, they are transmitted from the client devices 220-250 to the chat and video conference provider 210 via one or more networks where they are received by the real-time media servers 212. The real-time media servers 212 determine which protocol is optimal based on, for example, proxy settings and the presence of firewalls, etc. For example, the client device might select among UDP, TCP, TLS, or HTTPS for audio and video and UDP for content screen sharing.

The real-time media servers 212 then multiplex the various video and audio streams based on the target client device and communicate multiplexed streams to each client device. For example, the real-time media servers 212 receive audio and video streams from client devices 220-240 and only an audio stream from client device 250. The real-time media servers 212 then multiplex the streams received from devices 230-250 and provide the multiplexed stream to client device 220. The real-time media servers 212 are adaptive, for example, reacting to real-time network and client changes, in how they provide these streams. For example, the real-time media servers 212 may monitor parameters such as a client's bandwidth CPU usage, memory and network I/O) as well as network parameters such as packet loss, latency and jitter to determine how to modify the way in which streams are provided.

The client device 220 receives the stream, performs any decryption, decoding, and demultiplexing on the received streams, and then outputs the audio and video using the client device's video and audio devices. In this example, the real-time media servers do not multiplex client device 220′s own video and audio feeds when transmitting streams to it. Instead, each client device 220-250 only receives multimedia streams from other client devices 220-250. For telephony devices that lack video capabilities, e.g., client device 250, the real-time media servers 212 only deliver multiplex audio streams. The client device 220 may receive multiple streams for a particular communication, allowing the client device 220 to switch between streams to provide a higher quality of service.

In addition to multiplexing multimedia streams, the real-time media servers 212 may also decrypt incoming multimedia stream in some examples. As discussed above, multimedia streams may be encrypted between the client devices 220-250 and the chat and video conference provider 210. In some such examples, the real-time media servers 212 may decrypt incoming multimedia streams, multiplex the multimedia streams appropriately for the various clients, and encrypt the multiplexed streams for transmission.

As mentioned above with respect to FIG. 1, the chat and video conference provider 210 may provide certain functionality with respect to unencrypted multimedia streams at a user's request. For example, the meeting host may be able to request that the meeting be recorded or that a transcript of the audio streams be prepared, which may then be performed by the real-time media servers 212 using the decrypted multimedia streams, or the recording or transcription functionality may be off-loaded to a dedicated server (or servers), e.g., cloud recording servers, for recording the audio and video streams. In some examples, the chat and video conference provider 210 may allow a meeting participant to notify it of inappropriate behavior or content in a meeting. Such a notification may trigger the real-time media servers to 212 record a portion of the meeting for review by the chat and video conference provider 210. Still other functionality may be implemented to take actions based on the decrypted multimedia streams at the chat and video conference provider, such as monitoring video or audio quality, adjusting or changing media encoding mechanisms, etc.

It should be appreciated that multiple real-time media servers 212 may be involved in communicating data for a single meeting and multimedia streams may be routed through multiple different real-time media servers 212. In addition, the various real-time media servers 212 may not be co-located, but instead may be located at multiple different geographic locations, which may enable high-quality communications between clients that are dispersed over wide geographic areas, such as being located in different countries or on different continents. Further, in some examples, one or more of these servers may be co-located on a client's premises, e.g., at a business or other organization. For example, different geographic regions may each have one or more real-time media servers 212 to enable client devices in the same geographic region to have a high-quality connection into the chat and video conference provider 210 via local servers 212 to send and receive multimedia streams, rather than connecting to a real-time media server located in a different country or on a different continent. The local real-time media servers 212 may then communicate with physically distant servers using high-speed network infrastructure, e.g., internet backbone network(s), that otherwise might not be directly available to client devices 220-250 themselves. Thus, routing multimedia streams may be distributed throughout the video conference system and across many different real-time media servers 212.

Turning to the network services servers 214, these servers 214 provide administrative functionality to enable client devices to create or participate in meetings, send meeting invitations, create or manage user accounts or subscriptions, and other related functionality. Further, these servers may be configured to perform different functionalities or to operate at different levels of a hierarchy, e.g., for specific regions or localities, to manage portions of the chat and video conference provider under a supervisory set of servers. When a client device 220-250 accesses the chat and video conference provider 210, it will typically communicate with one or more network services servers 214 to access their account or to participate in a meeting.

When a client device 220-250 first contacts the chat and video conference provider 210 in this example, it is routed to a network services server 214. The client device may then provide access credentials for a user, e.g., a username and password or single sign-on credentials, to gain authenticated access to the chat and video conference provider 210. This process may involve the network services servers 214 contacting an authentication and authorization provider 215 to verify the provided credentials. Once the user's credentials have been accepted, and the user has consented, the network services servers 214 may perform administrative functionality, like updating user account information, if the user has account information stored with the chat and video conference provider 210, or scheduling a new meeting, by interacting with the network services servers 214. Authentication and authorization provider 215 may be used to determine which administrative functionality a given user may access according to assigned roles, permissions, groups, etc.

In some examples, users may access the chat and video conference provider 210 anonymously. When communicating anonymously, a client device 220-250 may communicate with one or more network services servers 214 but only provide information to create or join a meeting, depending on what features the chat and video conference provider allows for anonymous users. For example, an anonymous user may access the chat and video conference provider using client device 220 and provide a meeting ID and passcode. The network services server 214 may use the meeting ID to identify an upcoming or on-going meeting and verify the passcode is correct for the meeting ID. After doing so, the network services server(s) 214 may then communicate information to the client device 220 to enable the client device 220 to join the meeting and communicate with appropriate real-time media servers 212.

In cases where a user wishes to schedule a meeting, the user (anonymous or authenticated) may select an option to schedule a new meeting and may then select various meeting options, such as the date and time for the meeting, the duration for the meeting, a type of encryption to be used, one or more users to invite, privacy controls (e.g., not allowing anonymous users, preventing screen sharing, manually authorize admission to the meeting, etc.), meeting recording options, etc. The network services servers 214 may then create and store a meeting record for the scheduled meeting. When the scheduled meeting time arrives (or within a threshold period of time in advance), the network services server(s) 214 may accept requests to join the meeting from various users.

To handle requests to join a meeting, the network services server(s) 214 may receive meeting information, such as a meeting ID and passcode, from one or more client devices 220-250. The network services server(s) 214 locate a meeting record corresponding to the provided meeting ID and then confirm whether the scheduled start time for the meeting has arrived, whether the meeting host has started the meeting, and whether the passcode matches the passcode in the meeting record. If the request is made by the host, the network services server(s) 214 activates the meeting and connects the host to a real-time media server 212 to enable the host to begin sending and receiving multimedia streams.

Once the host has started the meeting, subsequent users requesting access will be admitted to the meeting if the meeting record is located and the passcode matches the passcode supplied by the requesting client device 220-250. In some examples additional access controls may be used as well. But if the network services server(s) 214 determines to admit the requesting client device 220-250 to the meeting, the network services server 214 identifies a real-time media server 212 to handle multimedia streams to and from the requesting client device 220-250 and provides information to the client device 220-250 to connect to the identified real-time media server 212. Additional client devices 220-250 may be added to the meeting as they request access through the network services server(s) 214.

After joining a meeting, client devices will send and receive multimedia streams via the real-time media servers 212, but they may also communicate with the network services servers 214 as needed during meetings. For example, if the meeting host leaves the meeting, the network services server(s) 214 may appoint another user as the new meeting host and assign host administrative privileges to that user. Hosts may have administrative privileges to allow them to manage their meetings, such as by enabling or disabling screen sharing, muting or removing users from the meeting, assigning or moving users to the mainstage or a breakout room if present, recording meetings, etc. Such functionality may be managed by the network services server(s) 214.

For example, if a host wishes to remove a user from a meeting, they may select a user to remove and issue a command through a user interface on their client device. The command may be sent to a network services server 214, which may then disconnect the selected user from the corresponding real-time media server 212. If the host wishes to remove one or more participants from a meeting, such a command may also be handled by a network services server 214, which may terminate the authorization of the one or more participants for joining the meeting.

In addition to creating and administering on-going meetings, the network services server(s) 214 may also be responsible for closing and tearing-down meetings once they have been completed. For example, the meeting host may issue a command to end an on-going meeting, which is sent to a network services server 214. The network services server 214 may then remove any remaining participants from the meeting, communicate with one or more real time media servers 212 to stop streaming audio and video for the meeting, and deactivate, e.g., by deleting a corresponding passcode for the meeting from the meeting record, or delete the meeting record(s) corresponding to the meeting. Thus, if a user later attempts to access the meeting, the network services server(s) 214 may deny the request.

Depending on the functionality provided by the chat and video conference provider, the network services server(s) 214 may provide additional functionality, such as by providing private meeting capabilities for organizations, special types of meetings (e.g., webinars), etc. Such functionality may be provided according to various examples of video conferencing providers according to this description.

Referring now to the video room gateway servers 216, these servers 216 provide an interface between dedicated video conferencing hardware, such as may be used in dedicated video conferencing rooms. Such video conferencing hardware may include one or more cameras and microphones and a computing device designed to receive video and audio streams from each of the cameras and microphones and connect with the chat and video conference provider 210. For example, the video conferencing hardware may be provided by the chat and video conference provider to one or more of its subscribers, which may provide access credentials to the video conferencing hardware to use to connect to the chat and video conference provider 210.

The video room gateway servers 216 provide specialized authentication and communication with the dedicated video conferencing hardware that may not be available to other client devices 220-230, 250. For example, the video conferencing hardware may register with the chat and video conference provider when it is first installed and the video room gateway may authenticate the video conferencing hardware using such registration as well as information provided to the video room gateway server(s) 216 when dedicated video conferencing hardware connects to it, such as device ID information, subscriber information, hardware capabilities, hardware version information etc. Upon receiving such information and authenticating the dedicated video conferencing hardware, the video room gateway server(s) 216 may interact with the network services servers 214 and real-time media servers 212 to allow the video conferencing hardware to create or join meetings hosted by the chat and video conference provider 210.

Referring now to the telephony gateway servers 218, these servers 218 enable and facilitate telephony devices' participation in meetings hosted by the chat and video conference provider 210. Because telephony devices communicate using the PSTN and not using computer networking protocols, such as TCP/IP, the telephony gateway servers 218 act as an interface that converts between the PSTN, and the networking system used by the chat and video conference provider 210.

For example, if a user uses a telephony device to connect to a meeting, they may dial a phone number corresponding to one of the chat and video conference provider's telephony gateway servers 218. The telephony gateway server 218 will answer the call and generate audio messages requesting information from the user, such as a meeting ID and passcode. The user may enter such information using buttons on the telephony device, e.g., by sending dual-tone multi-frequency (“DTMF”) audio streams to the telephony gateway server 218. The telephony gateway server 218 determines the numbers or letters entered by the user and provides the meeting ID and passcode information to the network services servers 214, along with a request to join or start the meeting, generally as described above. Once the telephony client device 250 has been accepted into a meeting, the telephony gateway server is instead joined to the meeting on the telephony device's behalf.

After joining the meeting, the telephony gateway server 218 receives an audio stream from the telephony device and provides it to the corresponding real-time media server 212 and receives audio streams from the real-time media server 212, decodes them, and provides the decoded audio to the telephony device. Thus, the telephony gateway servers 218 operate essentially as client devices, while the telephony device operates largely as an input/output device, e.g., a microphone and speaker, for the corresponding telephony gateway server 218, thereby enabling the user of the telephony device to participate in the meeting despite not using a computing device or video.

It should be appreciated that the components of the chat and video conference provider 210 discussed above are merely examples of such devices and an example architecture. Some video conference providers may provide more or less functionality than described above and may not separate functionality into different types of servers as discussed above. Instead, any suitable servers and network architectures may be used according to different examples.

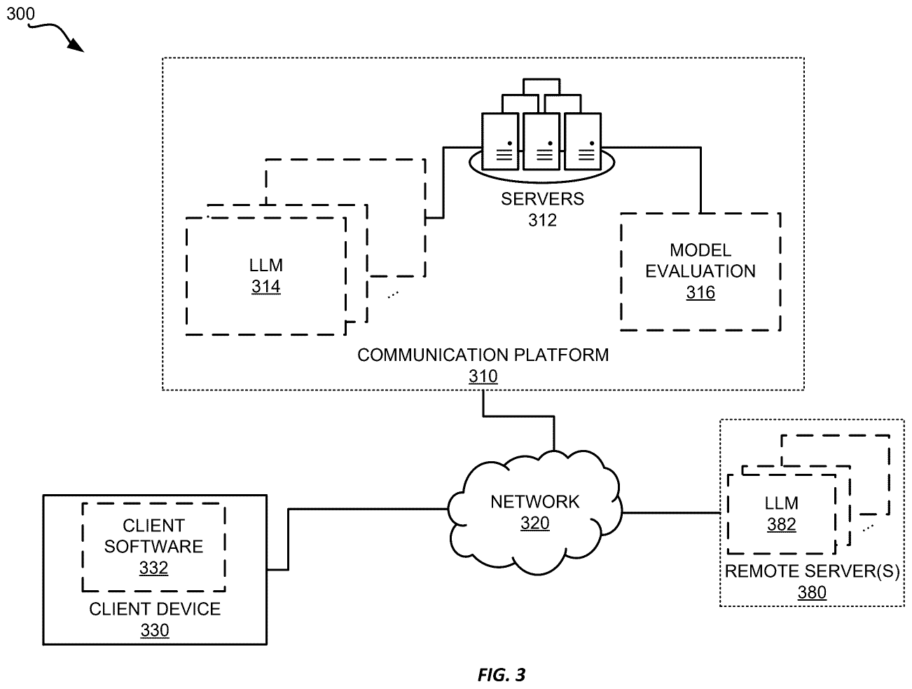

Referring now to FIG. 3, FIG. 3 shows an example system 300 for using LLMs to perform certain generative tasks based on communication data generated on a communication platform. In this example, the system 300 includes a client device 330, a communication platform 310, and one or more remote servers 380 that host one or more LLMs 382 in network communication with network 320. In this example, the communication platform 310 provides chat and virtual conferencing capabilities, such as discussed above with respect to FIGS. 1-2, but also provides one or more servers 312 that provide one or more LLMs 314 that may be used to service requests received from users via their respective client device, such as client device 330. In addition, the communication platform 310 provides model evaluation functionality 316 to evaluate language capabilities of LLMs and provide corresponding feedback.

The LLM 314 may be a model that has been trained on a large corpus of data, such as information available from licensed, commercially usable, non-public datasets. For LLMs, the training data may be written materials, such as webpages, documents, emails, or blogs that may be relevant to generating written works.

Client devices may execute client software 332 to join and participate in virtual conferences hosted by the communication platform 310. During a virtual conference, the participants can exchange audio and video streams, as discussed above with respect to FIGS. 1-2, to interact with each other, discuss any topics of interest, and share content. Similarly, the participants can continue any discussions outside of a virtual conference, such as by using chat functionality provided by the communication platform 310. They may also email each other using email services provided by the communication platform 310 or another third party.

Certain communication data can be provided to a trained machine learning (“ML”) model, such as an LLM, to perform a generative task based on the communication data, for example, to generate a summary of a meeting transcript. However, not all LLMs are equipped to handle communication data in a particular language.

Thus, the communication platform 310 employs a process for evaluating the language capabilities of one or more LLMs. By comparing evaluation scores corresponding to different LLMs, the communication platform 310 can select an LLM to perform a generative task based on the communications data.

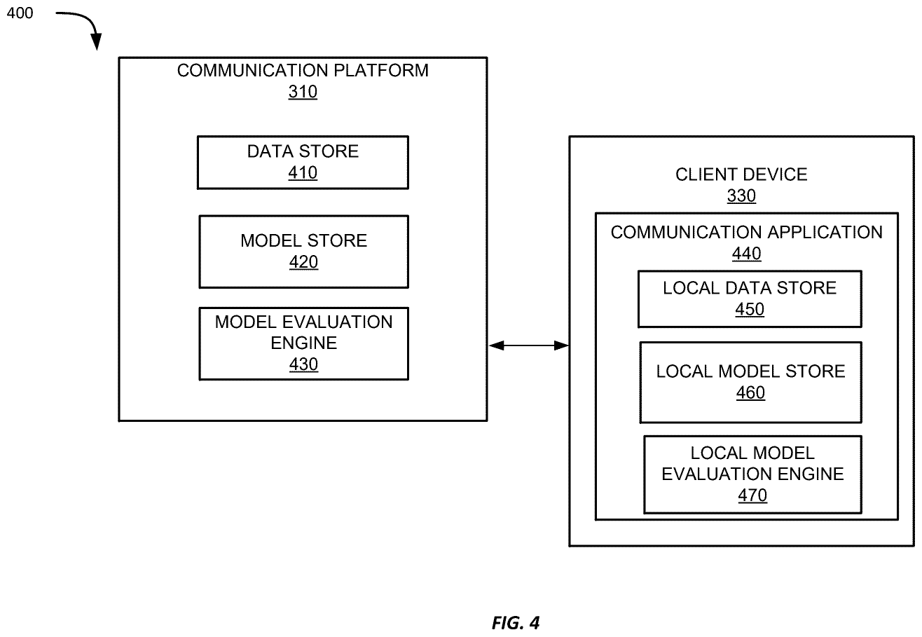

Referring now to FIG. 4, FIG. 4 shows an example system that is configured to evaluate the language capability of an LLM. The communication platform 310 is in network communication with a client device 330. The communication platform 310 includes a data store 410, a model store 420, and a model evaluation engine 430. The data store 410 stores historical communication data associated with different client devices 330, among other types of data. The historical communication data can include video conference recordings, video conference transcripts, chat messages, emails, and other types of communication data. The historical communication data can be used as inputs to LLMs for generating outputs for certain generative tasks. The outputs from the LLMs based on the inputs can also be stored in the data store 410.

The model store 420 includes different AI/ML models, including LLMs for various generative tasks in various languages. In some examples, the model store 420 stores the LLMs on the communication platform 310. In some examples, the model store 420 includes APIs for accessing various LLMs from different parts of the communication platform or from a third-party platform. The LLMs include an LLM that can be used as a reference LLM to generate a reference output for a generative task based on a reference input in a reference language. The reference LLM is often the one considered to perform the best in a high-resource language. For example, there is a vast amount of training datasets available in English, so English is often the reference language. GPT-4 is widely considered as the best LLM in English, so the reference LLM used for evaluating another LLM's language capability can be a GPT-4 model in English. Thus, the LLMs in the model store 420 can include GPT-4. However, if another LLM is deemed to be the best in a different language other than English, that LLM in that particular language can be used as a reference LLM for evaluation in the present disclosure. Thus, the LLMs in the model store 420 can include that particular LLM. The LLMs also include multiple other LLMs as target LLMs that can be evaluated and selected to perform certain generative tasks in different languages. Examples of target LLMs include GPT models of different versions, autoregressive LLMs (e.g., Large Language Model Meta A (LLAMA)), transformer-based autoregressive LLMs (e.g., BigScience Large Open-science Open-access Multilingual Language Models (BLOOMs)), Zephyr, MISTRAL, causal decoder-only models (e.g., Falcon), or MosaicML Pretrained Transformer (MPT) models.

The communication platform 310 can execute an LLM from the model store 420 as the target LLM to obtain a target output from a target input in a target language. The communication platform 310 can also execute an LLM from the model store 420 as the reference LLM to obtain a reference output from a reference input in a reference language. The target input and the reference input correspond to each other. For example, the reference input is a translation of the target input. The target language can be English or a different language, especially low-resource language with limited training datasets available. The reference language can be English, or another language considered as a high-resource language. The target output and the reference output can be provided to the model evaluation engine 430.

The model evaluation engine 430 is configured with model evaluation functionality 316 as shown in FIG. 3 to evaluate an LLM's language capability. The model evaluation engine 430 receives the reference output generated by the reference LLM using a reference input in a reference language and the target output generated by the target LLM using a target input in a target language.

The model evaluation engine 430 can implement a cross-lingual evaluation algorithm to generate an evaluation score representing a similarity between the target output in the target language and the reference output in the reference language. In some examples, the evaluation algorithm includes one or more pretrained cross-lingual encoders configured to generating embedding vectors, for example at sentence levels or word levels, for the reference output and the target output. Other suitable example evaluation algorithms may employ autoencoders, predictor models, or other deep neural networks. The embedding vectors can be processed to extract feature embeddings representing the differences between embedding vectors of the reference output and the target output. The feature embeddings are concatenated into one embedding vector. The evaluation algorithm can also include a neural network-based prediction or estimation model configured to process the combined embedding vector to predict a human judgement. The human judgement can be represented by direct assessment, human-mediated translation edit rate, a multidimensional quality metric, or other suitable cross-lingual evaluation metrics. An evaluation score for the target output can be obtained based on the predicted human judgement.

In some examples, the evaluation algorithm is a similarity algorithm, and the evaluation score based on a cross-lingual similarity metric. The cross-lingual similarity metric can be a vector similarity between the feature embeddings of the reference output and the target output. Alternatively, the cross-lingual similarity metric can be a meaning similarity between the reference output and the target output, considering a language confidence factor, a length penalty factor, or a language accuracy factor. The language confidence factor represents a confidence level that the target output is indeed being generated in the target language. The length penalty factor represents a brevity level of the target output, compared to the length of reference output. The language accuracy factor represents how often the target language model generates a target output in the target language. In some examples, a target LLM generates a target output in the reference language by mistake. The target LLM can be rewarded by a high similarity score. Considering the language accuracy factor, the similarity score is multiplied by a low language accuracy factor. In some examples, the evaluation algorithm is a reference-less machine translation evaluation algorithm, and the evaluation score is a reference-less machine translation metric to indicate if the target output is considered as a good translation of the reference output.

In some examples, the evaluation score can be provided as feedback to the target LLM for fine-tuning. If the evaluation score satisfies a predetermined threshold, it means that the target output generated by the target LLM is comparable to the reference output generated by the reference LLM. If the evaluation score does not satisfy the predetermined threshold, it means that the target output generated by the target LLM in the target language is not as good as the reference output generated by the reference LLM in the reference language. The communication platform can implement a reinforcement learning algorithm to fine-tune the target LLM based on evaluation scores from the model evaluation engine 430.

In some examples, the model evaluation engine 430 can evaluate multiple target LLMs to determine the best one for performing a generative task. The multiple target LLMs can generate multiple outputs for a generative task in the target language. The model evaluation engine 430 can generate multiple evaluation scores for the multiple target LLMs respectively, generally as described above. The model evaluation engine 430 can rank the multiple target LLMs based on the multiple evaluation scores. The target LLM with the highest evaluation score can be selected to perform generative tasks of the same type as the target generative task. In some examples, the communication platform 310 deploys the selected target LLM to be integrated with or accessible by the communication application 440, to perform generative tasks based on communication data generated from a communication session. For example, a video conference is established between different users via communication applications 440. The users speak Swedish in the video conference, a transcript of the video conference in Swedish is generated after the video conference. The selected target LLM can generate a summary of the video conference in Swedish based on the transcript of the video conference in Swedish. The model evaluation engine 430 can continuously evaluate the selected target LLM to generate an evaluation score, which can be used to fine-tune the selected target LLM.

In some examples, the model evaluation engine 430 can evaluate a target LLM over time. The target LLM can generate a first target output at a first time using the target input. The model evaluation engine 430 generates a first evaluation score for the first target output by comparing the first target output at the first time with the reference output. The target LLM can then generate a second target output at a second time later than the first time based on the same target input. The model evaluation engine 430 generates a second evaluation score for the second target output by comparing the second target output with the reference output. The model evaluation engine 430 can detect a model change by comparing the first evaluation score and the second evaluation score. If the second evaluation score is higher than the first evaluation score, it can indicate the target LLM has improved from the first time to the second time. If the second evaluation score is lower than the first evaluation score, it can indicate that the target LLM has drifted or decayed from the first time to the second time. If the second evaluation score is about the same as the first evaluation score, e.g., within a predefined threshold range, it can indicate that the target LLM has been stable. Following the example above, the selected target LLM can be evaluated continuously, the evaluation scores can be compared to detect if the selected target LLM has been changed over time. It may require a transcript in the reference language, and a specialized translation model may be used to provide the transcript in the reference language.

The communication application 440 installed on the client device 330 can be a client software 332 as shown in FIG. 3 provided by the communication platform 310. The communication application 440 can include a local data store 450, a local model store 460, and a local model evaluation engine 470. The local data store 450 can store local communication data, among other data related to a local user. The local model store 460 can store one or more reference LLM and multiple target LLMs for the local user to select a target LLM for certain generative tasks in a certain language. The local model evaluation engine 470 can be configured to evaluate one or more target LLMs by generating evaluation scores, similar to the model evaluation engine 430 as described above. The communication application 440 can also include a GUI for virtual communication, such as video conferences, chats, phone calls, or emails. The GUI can also provide a button for certain generative tasks. For example, one button in a GUI of a recorded video conference in Swedish can be associated with summary generation. A user can activate the button, which can trigger the selected target LLM to generate a summary of the video conference in Swedish based on the transcript of the video conference in Swedish.

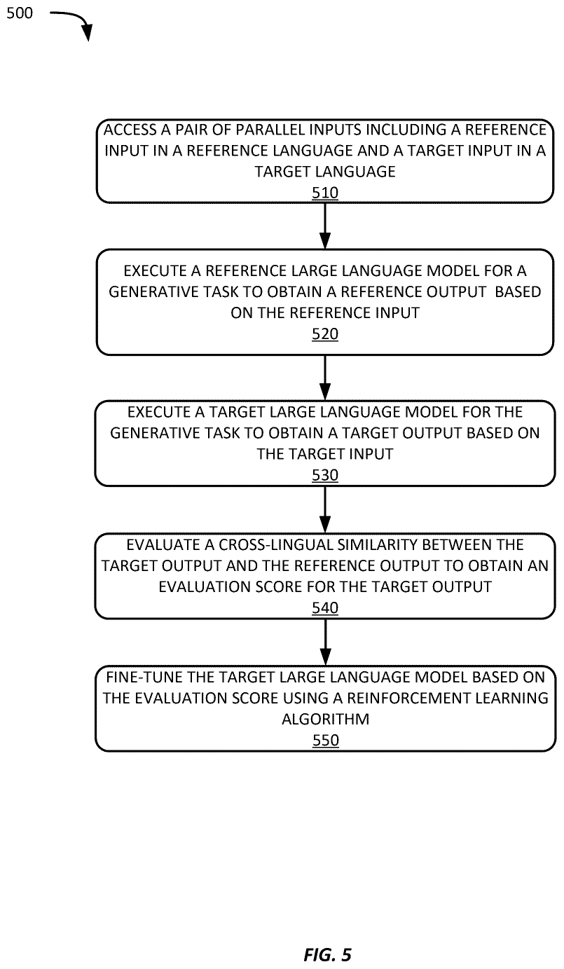

Referring now to FIG. 5, FIG. 5 shows an example method 500 for evaluating and improving language capability of a large language model. The example method 500 will be discussed with respect to the system 400 shown in FIG. 4; however, any suitable system for language capability evaluation of LLMs can be used.

At block 510, a communication platform 310 accesses a pair of parallel inputs including a reference input in a reference language and a target input in a target language. The reference input in the reference language corresponds to the target input in the target language different from the reference language. That is, the reference input in the reference language and the target input in the target language represent the same content but in different languages. The reference can be English, and the target language can be non-English or English. For example, the target input is a transcript in Swedish for a video conference and the reference input is a transcript in English for the same video conference. In some examples, the video conference is conducted in Swedish, and the transcript is generated in Swedish. The user can provide the transcript in Swedish to a machine translation model to obtain a transcript in English as the reference input.

At block 520, the communication platform 310 executes a reference LLM for a generative task to obtain a reference output based on the reference input. The reference LLM can be an LLM selected as having the best (e.g., strongest) generative performance trained with extensive annotated data in a certain language. For example, the reference LLM may be a GPT-4 model and the reference language may be English, since GPT-4 is arguably the best for generative tasks in English currently. However, if at later time, most annotated data are in a different language, and a different LLM is best trained for performing generative tasks, the different LLM can be used as the reference LLM. The reference LLM is stored in the model store 420 of the communication platform. Alternatively, the communication platform 310 can access the reference LLM via an API. The generative task can be any suitable task that can instruct an LLM to generate a type of output based on certain inputs. An example generative task can be summarization, which is to generate a summary of an input (e.g., transcript, chat messages, etc.). An example generative task can be paraphrasing, which is to paraphrase an input. An example generative task can be question-answer generation, which is to generate questions and answers based on an input (e.g., reports, articles, studies, webpage contents, etc.). An example generative tasks can be evaluation, which is to generate an evaluation of a written passage or a performance of a person in a virtual conference. Following the example at block 510, the generative task is to generate a summary. The reference LLM GPT-4 generates a summary based on the English transcription of the video conference.

At block 530, the communication platform 310 executes a target large language model for the generative task to obtain a target output based on the target input. The target LLM can be a GPT model or a non-GPT model. In some examples, the target LLM is an LLM trained with annotated data in a low-resource language, which may not have a vast amount of annotated data for training. The language capability of the target LLM for a generative task may not be known to a potential user. The communication platform 310 can access to the target LLM via an API. Alternatively, the target LLM is stored in the model store 420 of the communication platform 310. The target LLM can be deployed at the same time as the reference LLM. Alternatively, the target LLM and the reference LLM can be deployed one after the other in sequence. Following in the example at blocks 510 and 520, the target LLM generates a summary based on the Swedish transcript of the video conference.

At block 540, the communication platform 310 evaluates a cross-lingual similarity between the target output and the reference output to generate an evaluation score for the target output. In some examples, the target output and the reference output are provided to a model evaluation engine 430 on the communication platform 310. The model evaluation engine 430 can evaluate a cross-lingual similarity between the target output and the reference output, generally as described in FIG. 4. In some examples, the model evaluation engine 430 generates an evaluation score representing the similarity between the target output and the reference output. The evaluation score can indicate how similar the meaning of the reference output is to the meaning of the reference output. Alternatively, the evaluation score is a prediction of human judgement about how similar the target output is to the reference output. Still alternatively, the evaluations core indicates if the target output is considered as a good translation of the reference output.

At block 550, the communication platform 310 fine-tunes the target large language model based on the evaluation score using a reinforcement learning algorithm and suitable training data, e.g., from a commercially licensable training data set. In some examples, the evaluation score can be provided to the target LLM as feedback. The communication platform can implement a reinforcement learning algorithm to fine-tune the target LLM based on the evaluation score.

In some examples, the communication platform 310 can evaluate a target LLM over time. The target LLM generates a first output for a generative task based on a target input at a first time point, generally as described at block 530, and the communication platform 310 obtains a first evaluation score for the first output by evaluating a cross-lingual similarity between the first output and the reference output, generally as described at block 540. The target LLM generates a second output for a generative task based on the same target input at a second time point, generally as described at block 530, and the communication platform 310 obtains a second evaluation score for the second output by evaluating a cross-lingual similarity between the second output and the reference output, generally as described at block 540. The communication platform 310 obtains the reference output, generally as described at block 520. The first evaluation score and the second evaluation score can be compared to evaluate the performance of the target LLM from the first time point to the second time point. For example, the second evaluation score is higher than the first evaluation score, indicating the target LLM has improved since the first time point for the generative task in the target language. The target LLM may be retrained or fine-tuning itself during this time. Also as an example, the second evaluation score is lower than the first evaluation score, indicating the target LLM has a model drift. Also as an example, the second evaluation score is about the same as the first evaluation score, indicating that the target LLM maintains the same.

In some examples, the communication platform 310 evaluates multiple LLMs to determine a best LLM for a generative task in a certain language. Multiple target outputs can be generated by the multiple LLMs using the same target input. Multiple evaluations scores can be obtained for the multiple target outputs by evaluating a cross-lingual similarity between a target output and the reference output. The multiple evaluation scores can be ranked. The LLM corresponding to the highest evaluations core can be selected to perform the generative task in the target language.

In some examples, multiple target LLMs can be deployed at block 530 to generate multiple target outputs based on the target input. The model evaluation engine 430 can evaluate a cross-lingual similarity between the multiple target outputs and the reference output to obtain multiple evaluation scores for the multiple target LLMs, generally as described at block 540. One target LLM is selected based on its evaluation score, for example the target LLM with the highest evaluation score is selected. The selected target LLM can be deployed for summary generation or other generative tasks, based on communication data generated from a communication session on the communication platform 310. The model evaluation engine 430 can evaluate the selected target LLM continuously to fine-tune or detect a model change.

The example process 500 illustrates a method for evaluating language capabilities of LLMs. However, not every step in the example process 500 may be needed, or some other steps may be added. The example process 500 is performed by a communication platform 310. Alternatively, the example process 500 can be performed by a communication application 440 installed on a client device 330.

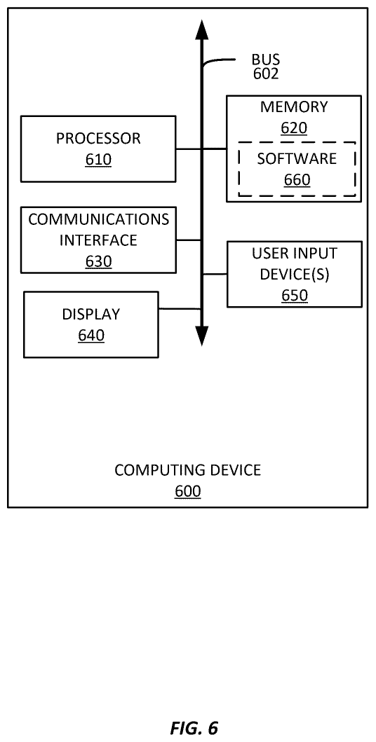

Referring now to FIG. 6, FIG. 6 shows an example computing device 700 suitable for use in example systems or methods for evaluating language capabilities of a LLM according to this disclosure. The example computing device 600 includes a processor 610 which is in communication with the memory 620 and other components of the computing device 600 using one or more communications buses 602. The processor 610 is configured to execute processor-executable instructions stored in the memory 620 to perform one or more methods for evaluating language capabilities of a LLM according to different examples, such as part or all of the example method 500 described above with respect to FIG. 5. In some embodiments, the computing device may include software 660 for executing one or more methods described herein, such as for example, one or more steps of method 500. The computing device 600, in this example, also includes one or more user input devices 650, such as a keyboard, mouse, touchscreen, microphone, etc., to accept user input. The computing device 600 also includes a display 640 to provide visual output to a user.

The computing device 600 also includes a communications interface 630. In some examples, the communications interface 630 may enable communications using one or more networks, including a local area network (“LAN”); wide area network (“WAN”), such as the Internet; metropolitan area network (“MAN”); point-to-point or peer-to-peer connection; etc. Communication with other devices may be accomplished using any suitable networking protocol. For example, one suitable networking protocol may include the Internet Protocol (“IP”), Transmission Control Protocol (“TCP”), User Datagram Protocol (“UDP”), or combinations thereof, such as TCP/IP or UDP/IP.

While some examples of methods and systems herein are described in terms of software executing on various machines, the methods and systems may also be implemented as specifically configured hardware, such as field-programmable gate array (FPGA) specifically to execute the various methods according to this disclosure. For example, examples can be implemented in digital electronic circuitry, or in computer hardware, firmware, software, or in a combination thereof. In one example, a device may include a processor or processors. The processor comprises a computer-readable medium, such as a random-access memory (RAM) coupled to the processor. The processor executes computer-executable program instructions stored in memory, such as executing one or more computer programs. Such processors may comprise a microprocessor, a digital signal processor (DSP), an application-specific integrated circuit (ASIC), field programmable gate arrays (FPGAs), and state machines. Such processors may further comprise programmable electronic devices such as PLCs, programmable interrupt controllers (PICs), programmable logic devices (PLDs), programmable read-only memories (PROMs), electronically programmable read-only memories (EPROMs or EEPROMs), or other similar devices.

Such processors may comprise, or may be in communication with, media, for example one or more non-transitory computer-readable media, that may store processor-executable instructions that, when executed by the processor, can cause the processor to perform methods according to this disclosure as carried out, or assisted, by a processor. Examples of non-transitory computer-readable medium may include, but are not limited to, an electronic, optical, magnetic, or other storage device capable of providing a processor, such as the processor in a web server, with processor-executable instructions. Other examples of non-transitory computer-readable media include, but are not limited to, a floppy disk, CD-ROM, magnetic disk, memory chip, ROM, RAM, ASIC, configured processor, all optical media, all magnetic tape or other magnetic media, or any other medium from which a computer processor can read. The processor, and the processing, described may be in one or more structures, and may be dispersed through one or more structures. The processor may comprise code to carry out methods (or parts of methods) according to this disclosure.

The foregoing description of some examples has been presented only for the purpose of illustration and description and is not intended to be exhaustive or to limit the disclosure to the precise forms disclosed. Numerous modifications and adaptations thereof will be apparent to those skilled in the art without departing from the spirit and scope of the disclosure.

Reference herein to an example or implementation means that a particular feature, structure, operation, or other characteristic described in connection with the example may be included in at least one implementation of the disclosure. The disclosure is not restricted to the particular examples or implementations described as such. The appearance of the phrases “in one example,” “in an example,” “in one implementation,” or “in an implementation,” or variations of the same in various places in the specification does not necessarily refer to the same example or implementation. Any particular feature, structure, operation, or other characteristic described in this specification in relation to one example or implementation may be combined with other features, structures, operations, or other characteristics described in respect of any other example or implementation.

Use herein of the word “or” is intended to cover inclusive and exclusive OR conditions. In other words, A or B or C includes any or all of the following alternative combinations as appropriate for a particular usage: A alone; B alone; C alone; A and B only; A and C only; B and C only; and A and B and C.

That which is claimed is:

1. A method comprising:
accessing a pair of parallel inputs comprising a reference input in a reference language and a target input in a target language, wherein the reference input in the reference language corresponds to the target input in the target language, the target language different from the reference language;
executing a reference large language model for a generative task to obtain a reference output in the reference language based on the reference input;
executing a target large language model for the generative task to obtain a target output in the target language based on the target input;
evaluating a cross-lingual similarity between the target output and the reference output to obtain an evaluation score; and
fine-tuning the target large language model based on the evaluation score using a reinforcement learning algorithm.

2. The method of claim 1, wherein the target input comprises communication data in the target language on a communication platform, comprising meeting transcripts, chat messages, audio messages, and emails.

3. The method of claim 1, wherein the reference large language model is a Generative Pre-trained Transformer 4 (GPT-4), and wherein the reference language is English.

4. The method of claim 2, wherein the target language is non-English, wherein the target large language model comprises a GPT model or a non-GPT model.

5. The method of claim 1, further comprising translating the target input in the target language to obtain the reference input in the reference language using a machine translation model.

6. The method of claim 1, wherein the generative task comprises summarization, paraphrasing, or question-answer generation.

7. The method of claim 1, wherein the evaluation score comprises a reference-less machine translation metric, a similarity metric, or a predicted estimate for human judgment.

8. The method of claim 1, further comprising:
deploying multiple large language models for the generative task to generate multiple outputs based on the target input;
evaluating a similarity between each output of the multiple outputs and the reference output to generate multiple evaluation scores;
ranking the multiple large language models based on the multiple evaluation scores for the multiple large language models; and
selecting a large language model corresponding to a highest evaluation score for the generative task in the target language.

9. The method of claim 1, further comprising:
obtaining a first output generated from a target input by using the target large language model for the generative task at a first time;
evaluating a first similarity between the first output and the reference output to generate a first evaluation score;
obtaining a second output generated from the target input by using the target large language model for the generative task at a second time later than the first time;
evaluating a second similarity between the second output and the reference output to generate a second evaluation score; and
detecting a model drift of the target large language model based on a different between the first evaluation score and the second evaluation score.

10. A system comprising:
a communications interface;
a non-transitory computer-readable medium; and
one or more processors communicatively coupled to the communications interface and the non-transitory computer-readable medium, the one or more processors configured to execute processor-executable instructions stored in the non-transitory computer-readable medium to:
access a pair of parallel inputs, comprising a reference input in a reference language and a target input in a target language, wherein the reference input in the reference language corresponds to the target input in the target language different from the reference language;
execute a reference large language model for a generative task to obtain a reference output in the reference language based on the reference input;
execute a target large language model for the generative task to obtain a target output in the target language based on the target input;
evaluate a cross-lingual similarity between the target output and the reference output to obtain an evaluation score; and
fine-tune the target large language model based on the evaluation score using a reinforcement learning algorithm.

11. The system of claim 10, wherein the target input comprises communication data in the target language on a communication platform, comprising meeting transcripts, chat messages, audio messages, and emails.

12. The system of claim 10, wherein the reference large language model is a Generative Pre-trained Transformer 4 (GPT-4), wherein the target large language model comprises a GPT model or a non-GPT model, wherein the reference language is English, and wherein the target language is non-English.

13. The system of claim 10, wherein the one or more processors are configured to execute further processor-executable instructions stored in the non-transitory computer-readable medium to:
translate the target input in the target language to obtain the reference input in the reference language using a machine translation model.

14. The system of claim 10, wherein the generative task comprises summarization, paraphrasing, or question-answer generation.

15. The system of claim 10, wherein the evaluation score comprises a reference-less machine translation metric, a vector-based similarity metric, or a semantic similarity metric.

16. The system of claim 10, wherein the one or more processors are configured to execute further processor-executable instructions stored in the non-transitory computer-readable medium to:
deploy multiple large language models for the generative task to generate multiple outputs based on the target input;
evaluate a similarity between each output of the multiple outputs and the reference output to generate multiple evaluation scores for the multiple large language models;
rank the multiple large language models based on the multiple evaluation scores; and
select a large language model corresponding to a highest evaluation score for the generative task in the target language.

17. A non-transitory computer-readable medium comprising processor-executable instructions configured to cause one or more processors to:
access a pair of parallel inputs, comprising a reference input in a reference language and a target input in a target language, wherein the reference input in the reference language corresponds to the target input in the target language different from the reference language;
execute a reference large language model for a generative task to obtain a reference output in the reference language based on the reference input;
execute a target large language model for the generative task to obtain a target output in the target language based on the target input;
evaluate a cross-lingual similarity between the target output and the reference output to obtain an evaluation score; and
fine-tune the target large language model based on the evaluation score using a reinforcement learning algorithm.

18. The non-transitory computer-readable medium of claim 17, wherein the target input comprises communication data in the target language on a communication platform, comprising meeting transcripts, chat messages, audio messages, and emails.

19. The non-transitory computer-readable medium of claim 17, wherein the reference large language model is a Generative Pre-trained Transformer 4 (GPT-4), wherein the target large language model comprises a GPT model or a non-GPT model, wherein the reference language is English, and wherein the target language is non-English.

20. The non-transitory computer-readable medium of claim 17, further comprising processor-executable instructions configured to cause one or more processors to:
obtain a first output generated from a target input by using the target large language model for the generative task at a first time;
evaluate a first similarity between the first output and the reference output to generate a first evaluation score;
obtain a second output generated from the target input by using the target large language model for the generative task at a second time later than the first time;
evaluate a second similarity between the second output and the reference output to generate a second evaluation score; and
detect a model drift of the target large language model based on a different between the first evaluation score and the second evaluation score.
